(19) United States
(12) Patent Application Publication
(10) Pub. No.: US 2011/0276498 A1
(43) Pub. Date: Nov. 10, 2011

(54) PROCESS AND SYSTEM FOR ESTIMATING RISK AND ALLOCATING RESPONSIBILITY FOR PRODUCT FAILURE

(75) Inventor: Varun Madhok, Toronto (CA)

(73) Assignee: INFERNOTIONS TECHNOLOGIES LTD, Toronto (CA)

(21) Appl. No.: 12/898,803

(22) Filed: Oct. 6, 2010

Related U.S. Application Data
(60) Provisional application No. 61/331,376, filed on May 4, 2010.

(51) Int. Cl. G06Q 10/00

(52) U.S. Cl. 705/302

(57) ABSTRACT

The invention is a process and a system for identifying the risk areas in a manufacturer's logistic processes and for allocating responsibility for product unit failure to discrete events in the products' lifetimes. The system comprises one or multiple abuse sensors that are co-located with the product units or their containers, one or multiple readers for capturing sensor data, a data transfer utility for dispatching the recorded data to a database and an analysis module. The analysis module aggregates data across the product units returned to the manufacturer, measures the risk of product failure due to specific events of interest in the products' lifetime and estimates the associated costs.

### CROSS-REFERENCE TO RELATED APPLICATIONS

This application claims the benefit of U.S. Provisional Application Ser. No. 61/331,376, filed on May 4, 2010. The disclosure of the above application is incorporated herein by reference in its entirety for any purpose.

### FIELD OF THE INVENTION

The present invention generally relates to manufacturer warranty, and particularly relates to system and process for assessing the risk and responsibility for product failure as a component of the manufacturer's warranty claims processing.

### BACKGROUND OF THE INVENTION

Manufacturer warranty is an assurance to the end-user that if a unit fails within a specified duration from the time of sale then the product will be replaced or repaired at no charge to the end-user. This assurance however assumes that the product will not be subject to conditions or to a usage that is unusual or beyond the tolerance levels of the unit. More specifically, a consumer electronics manufacturer reserves the right to reject the warranty claim on a unit that has been subjected to mechanical abuse such as a drop to the ground. The cost to service and support the warranty claims is still a burden on the manufacturers. Not only is it important for a manufacturer to ascertain whether the unit owner is culpable for unit damage, it is important for the manufacturer to isolate the root causes for warranty claims and allocate their cumulative risk to profitability. Ultimately the financial burden to the manufacturer for such risk is the warranty loss reserve that is used to pay for future claim losses. Thus there is a need to identify systemic issues within the logistics process that are leading to warranty claims or inventory shrinkage. The lack of such a system and process is a blind spot in the manufacturer's logistics process and a gap in current processes for reliability analysis. The present invention addresses this blind spot.

It is an objective of the present invention to define a process for capturing the events data through the product lifetime, and the fusion of these data with the claims information on the product when returned for repair or replacement.

It is further an objective of the present invention to diagnose a causal relationship between events data in manufacturer's logistic process and the subsequent product breakdown. Some examples of problem areas that can be diagnosed using the present invention are problems in product design or packaging, and/or poor product handling by carriers.

It is further an objective of the present invention to measure the risks associated with distinct characteristics of the logistics process including, but not restricted to, product design, distribution channels, parts sourcing and claims handling.

It is further an objective of the present invention to allocate the responsibility of product failure to the various stakeholders involved in a manufacturer's logistic process, or product use throughout the lifetime of the product.

It is still further an objective of the present invention to assist manufacturer to assess the business case of making changes to existing business processes in product design, engineering, user documentation, packaging and handling etc. to address systemic product problems versus other options such as recalls or exchanges.

### SUMMARY OF THE INVENTION

According to the present invention, the system comprises an event data recorder or sensor, a reader to read data off the sensor, a sub-system to transfer the read data to a pre-specified location from where the data are uploaded into a repository of historical data on the reverse logistics process; and an analysis module that delivers a reliability assessment based on the statistical analysis of failure patterns in the logistics process.

According to another feature of the present invention, the analysis module gauges the risk of warranty losses with specific characteristics in the manufacturer's logistics process.

According to yet another feature of the present invention, the system could be physically distributed across multiple locations—the processes of data integration, data fusion, and report generation are functions of the analysis module.

According to yet another critical feature of the present invention, abuse events are recorded on the individual product unit as discrete events with a timestamp. One application of this feature is in understanding the number of abuse events a unit can sustain before failure.

According to yet another feature of the present invention, the analysis module generates reports using data aggregated across multiple units sharing a similar behavioral profile. These reports are used to understand long-term warranty implications on a given class of product due to ongoing issues with product design, engineering, usage or handling.

According to yet another feature of the present invention, a product warranty claim acceptance or denial decision is drawn based on the result of individual unit report or ensemble report or combination thereof.

The present invention is advantageous over previous manufacturer warranty claim processing and reliability analysis systems in that the present invention integrates and fuses data, including the timestamps, from multiple sources in the manufacturer logistic process. Therefore it is possible to accurately allocate the responsibility of product abuse. It is also possible to estimate the risk of warranty losses associated with specific characteristics of the logistics process.

For a more thorough understanding of the invention, its objectives and advantages refer to the following specification and to the accompanying drawings.

### BRIEF DESCRIPTION OF THE DRAWINGS

The present invention will become more fully understood from the detailed description and the accompanying drawings, wherein:

FIG. 1 is an exemplary representation of entities or role players in a logistics process;

FIG. 2 is an exemplary process flow representing the extraction, transfer and analysis of data according to the present invention;

FIG. 3 is a continuation of the process flow shown in FIG. 2 according to the present invention;

FIG. 4 is an exemplary diagrammatic view of the constituent components according to the present invention;

FIG. 5 is an exemplary laptop manufacturer's reverse logistics process according to the present invention.

FIG. 6 is an exemplary home appliance manufacturer's reverse logistics process according to the present invention.

FIG. 7 represents an exemplary integration of information from distinct points in the product logistics process according to the present invention.

FIG. 8 is an exemplary sample output ensemble report according to the present invention.

FIG. 9 is an exemplary sample output ensemble report in according to the present invention.

FIG. 10 is an exemplary sample output unit report according to the present invention.

FIG. 11 is an exemplary illustration of the use of principal component analysis for understanding the relationship between product abuse and claim events data according to the present invention.

### DETAILED DESCRIPTION OF EMBODIMENTS

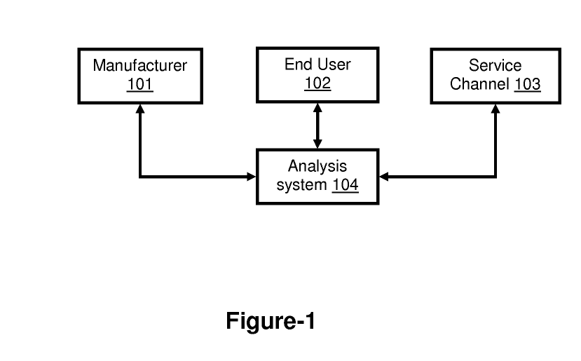

The present invention targets the ecosystem occupied by a unit (or a production batch) in the time from when it comes off the production line through to when it is returned to the manufacturer. This ecosystem is represented through its constituent entities in FIG. 1. The manufacturer 101 is the entity that is accountable for the product unit(s) being transacted. This entity provides a measure of guarantee that the article being sold or traded is free of defect. It also has a vested interest in understanding where defects originate. The end-user 102 is the entity who receives the product from the manufacturer 101. The end-user 102 can be the product reseller or the consumer. In the reverse logistics process flow the end-user 102 is the entity with whom the returns originate. The service channel 103 is the entity between the end-user and the manufacturer that receives the returned article from the end-user 102. The service channel 103 can be a repair depot or a goods carrier. The analysis system 104 assimilates data obtained from the three aforementioned entities and generates the risk+responsibility reports.

The output of the analysis system 104 are one or more of a set of reports that are broadly characterized as ‘unit’ and ‘ensemble’ reports. The distinctions between the unit report and the ensemble report, and the exemplary applications, are listed in Table 1 below.

TABLE 1
Unit report and ensemble report in an analysis system.

| | Unit report | | Ensemble report | |
|---|---|---|---|---|
| Data | Uses data on discrete | | Uses data on abuse events | |
| requirements | abuse events recorded on | | recorded on multiple units in a | |
| | a single unit with the | | product batch or products sharing a | |
| | respective timestamps. | | similar behavioral profile over the | |
| | | | same observation period. | |
| | | | Abuse events are recorded as | |
| | | | aggregates - at a daily or weekly or | |
| | | | monthly level (or any other | |
| | | | frequency deemed appropriate for | |
| | | | the purpose). | |
| Business | Provides information on | | Provides insight on how and why | |
| purpose | what transpired. | | product units failed. Provides insight | |
| | | | on what's the best or the worst that | |
| | | | could happen in the future. | |
| Inventive | Innovation comprises data | | Innovation comprises data fusion | |
| contribution | fusion across different | | across the manufacturers' logistics | |
| | sources and over a | | universe, statistical analysis for the | |
| | timeline. | | associated risks and responsibilities | |
| | | | for warranty claims. | |
| Usage | Used in tracing the history | | Used for ascertaining the need for | |
| | of the product between the | | business process transformation | |
| | dispatch from the | | and associated cost-benefits. | |
| | manufacturer and the | | | |
| | return to the service | | | |
| | center. | | | |
| Examples of | 1. | Did the abuse occur | 1. | What abuse events lead to |
| questions | | and when? | | warranty claims? |
| that can be | 2. | Who was | 2. | What magnitude of abuse |
| answered by | | responsible for the | | leads to warranty claims? |
| the report | | product unit when | | (Or) What is the acceptable |
| | | the abuse occurred? | | tolerance level of a product to |
| | | [This is done | | abuse? |
| | | through a simple | 3. | How much packaging is |
| | | juxtaposition of the | | necessary to minimize |
| | | events data on the | | product damage or shrinkage |
| | | timeline indicating | | in transit? |
| | | the ownership of the | 4. | What is the risk of shrinkage |
| | | product through its | | associated with shipping |
| | | lifetime] | | using a specific channel? |
| | 3. | What transpired at | 5. | If the abuse events lead to |
| | | the moment of | | warranty claims what is the |
| | | abuse? [e.g. did the | | lag between the event and |
| | | product fall over? If | | the bump in resulting |
| | | it was impacted, | | increased warranty claims? |
| | | what was the angle | 6. | Should the entity or person |
| | | of impact?] | | responsible for the product |
| | | | | unit when the abuse event |
| | | | | was recorded be responsible |
| | | | | for the product failure? The |
| | | | | working hypothesis is that not |
| | | | | all abuse events lead to |
| | | | | product failure and a |
| | | | | customer or carrier should |
| | | | | not be penalized for events |
| | | | | that are well within the |
| | | | | tolerance level of the product |
| | | | | unit. |

The invention comprises a process for data measurement, data fusion and analytics across the logistics process. This process is facilitated through a system that is described below.

In one embodiment of the present invention, the analysis system can be implemented on a computer that resides either at manufacturer's site, server channel partner's site or a third-party service provider's site. In another embodiment, the analysis system is a stand-alone device.

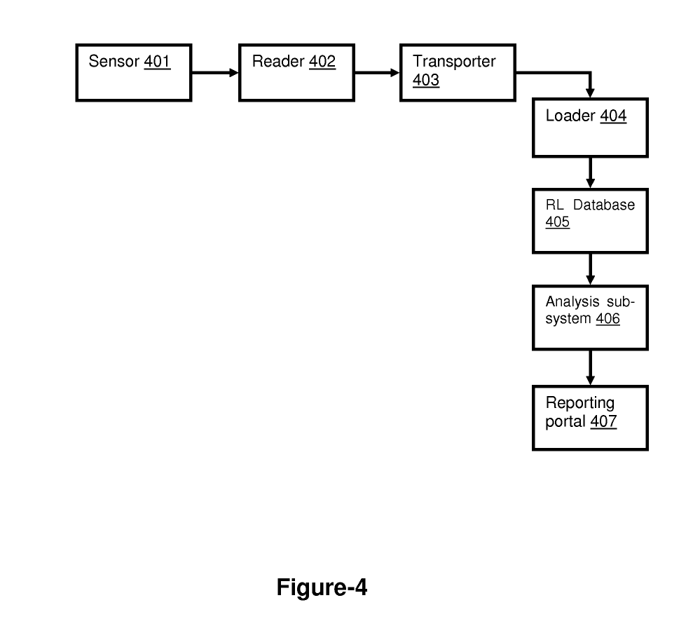

The analysis system 104 is further deconstructed into its component parts in FIG. 4. These parts are itemized below.

a) Sensor 401: Data originates with a measurement device called the sensor 401. The sensor is a device that transforms (or transduces) physical quantities such as pressure or acceleration or temperature change (called measurands) into output signals that can be transmitted or recorded. The sensor is located on the unit whose performance is guaranteed by the manufacturer. In another embodiment of the invention, the sensor can be installed on a product batch or elsewhere in the proximity of the unit that records events in the lifetime of the product unit. Examples of these sensors are described in U.S. Pat. No. 5,542,297 “Acceleration sensor” and U.S. Pat. No. 5,684,456 “Tilt-sensor”. A key feature of the sensor is the capability to link a timestamp to all data readings.
b) Reader 402: The data that is captured on the sensor is read using a reader and recorded to a memory device. For example, a typical implementation of this design would have an active RFID device used in the sensor, whether passive or active, and a handheld device as a portable reader or scanner to read the data off the sensor and record to a personal computer, which data will be sent to the analysis system later. There can also be other ways to read the sensor data, for example, through Blue-tooth, IrDA, wireless radio link or wired data links.
c) Transporter 403: On data transport layer, the sensor data can be transmitted in proprietary protocol or any standard. The manufacturer's products may be spread over a wide geography and a transmission device is needed to transfer the data from the recorded medium to a central location where analysis takes place. This transmission device is identified as the transporter 403 in FIG. 4.
d) RL Database 405, Loader 404: In reference to FIG. 4, the data from all sensors are located in a central location. These data are uploaded into a Reverse Logistics (RL) Database 405 using the loader 404. The loader is a mechanism that detects the presence of new sensor data as transferred by the transporter. The RL database 405 integrates information from the sensor to the warranty information and the characteristics of the respective units on which the sensor had been dispatched. For instance, the RL Database can contain the warranty expiration date, the serial number, the shipment date, the owner information on every washing machine shipped by a home appliances manufacturer. The sensor data, when received, will contain the serial number of the washing machine on which the sensor was installed as well as readings on any events that have been recorded since the appliance left the manufacturer's warehouse. The serial number is then used to link the sensor data to the appliance warranty information.
e) Analysis sub-system 406: The data in the RL Database is made available to an analysis sub-system 406 for various reliability analyses on the product failure patterns. The analysis sub-system processes the data to identify events of note in the unit history. The Analysis sub-system 406 also creates an ensemble profile of sensor readings to identify patterns of misuse among the units to which the sensor 401 was assigned.
f) Reporting portal 407: The results from the Analysis sub-system 406 are delivered via a reporting portal 407 to the manufacturer or service channel partner. In one embodiment of the invention, the system is designed to work in the distributed environment for which the delivery mechanism is via an Internet portal. The RL database could be residing in the analysis system or in a separate location and can be accessed remotely.

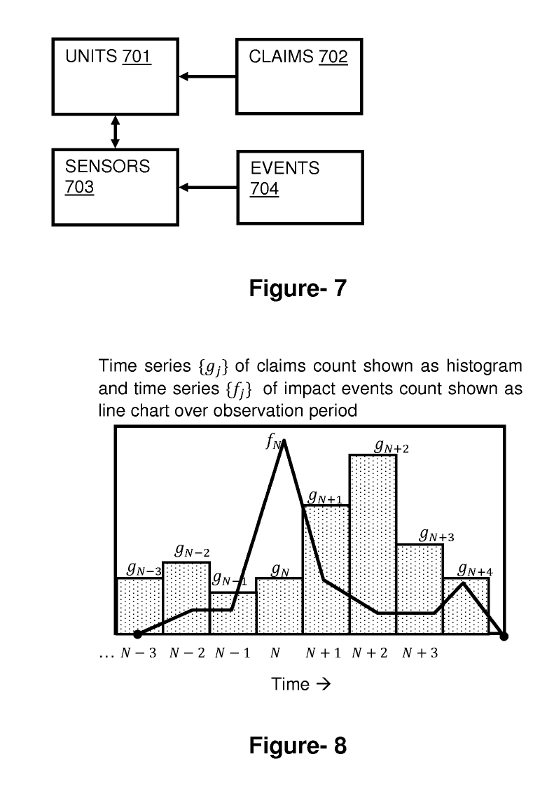

The analytical sub-system is dependent on the integration and fusion of disparate data into the centralized data repository also known as the RL database 405 in FIG. 4. FIG. 7 lists the data concepts in the data repository and the associated relationships. These data concepts are essential to deployment of the RL database in a commercial relational database management system.

FIG. 7 comprises four entities—‘Units’ 701, ‘Claims’ 702, ‘Sensors’ 703 and ‘Events’ 704. All embodiments of this invention lever variations to the design shown in FIG. 7. In one implementation the data entity identified as ‘Units’ 701 comprises information on its sales, ownership and ship date. ‘Sensors’ 703 captures data on the abuse sensors, the units of their installation, installation dates and initialization parameters. The ‘Claims’ 702 data entity comprises information on the returned unit, details on the observed defects and the timeline of the return. The ‘Events’ 704 data entity comprises the events data recorded on the sensors. The arrowheads as shown in FIG. 7 represent the linkage among the entities. In summary, product units have claims and are installed with abuse sensors. These sensors record (abuse) events. A unit can have multiple claims and a sensor can record multiple Events. Units and sensors may not have uniquely one-to-one relationships. A unit may be linked to one or many sensors and vice versa.

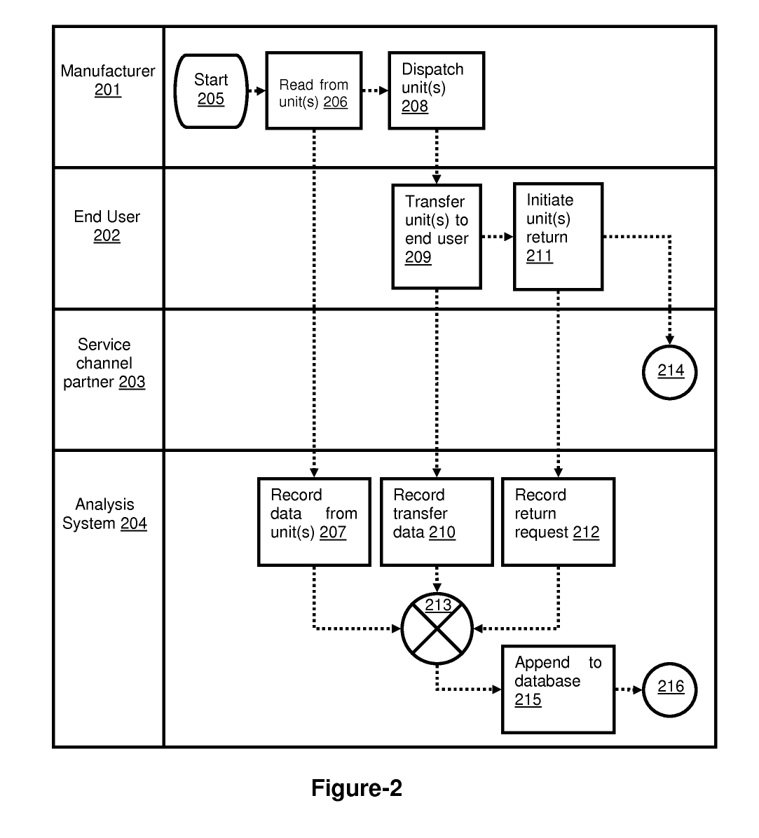

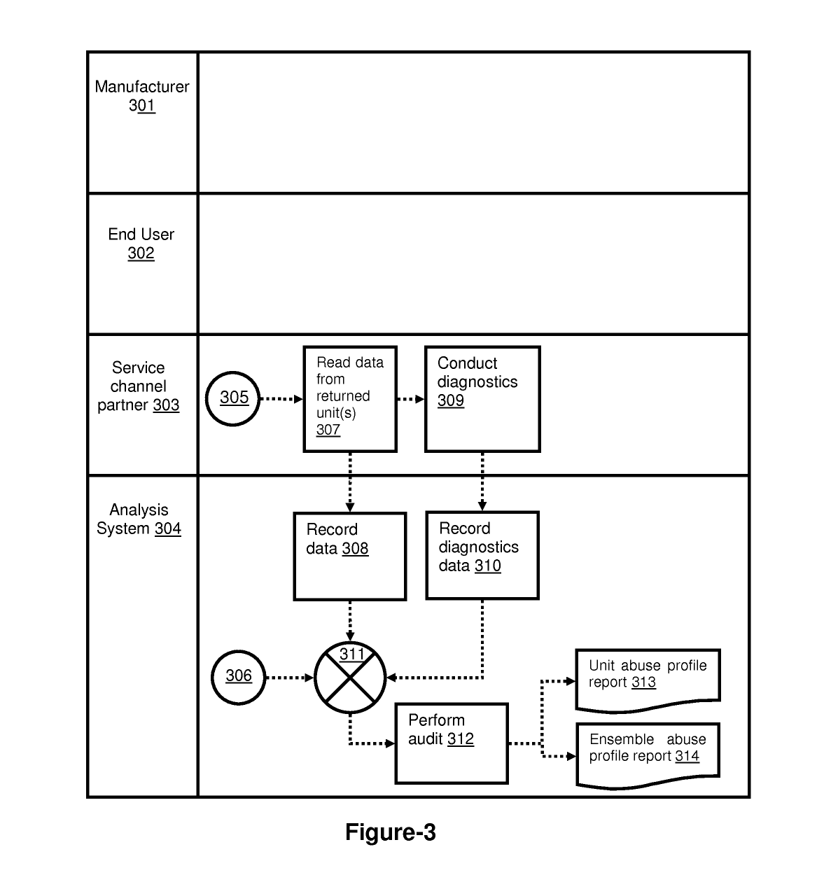

FIG. 2 and FIG. 3 capture the process that governs the usage of the system defined using FIG. 1, FIG. 4 and FIG. 7. The key tasks delivered are measurement, monitoring and analysis of data representing the various phenomena across the logistics process, and their implication on warranty claims.

In reference to FIG. 2, the process starts at step 205, the stage where the manufacturer 201 completes a production batch and initiates the transfer of the unit(s) to the end-user 202. The sensor 401, as illustrated in FIG. 4, is attached or contained within the unit. The sensor 401 will not be detached or disabled from this point until the phase where the unit is back with the manufacturer 201 at which point the accountability for the unit indisputably reverts to the manufacturer. In some cases a single sensor may be used for a batch, in others there may be multiple sensors attached to a single unit, or there may be one sensor attached with each unit in a batch. In the next step, the data on the sensor capturing the state of the system, and other information such as the production date and the production batch identifier are read, in step 206, and transmitted to the analysis system 204. The data are recorded, in step 207, and then integrated, in step 213, to a database 215. After data are read from the unit, the units are dispatched to the end-user, in step 208.

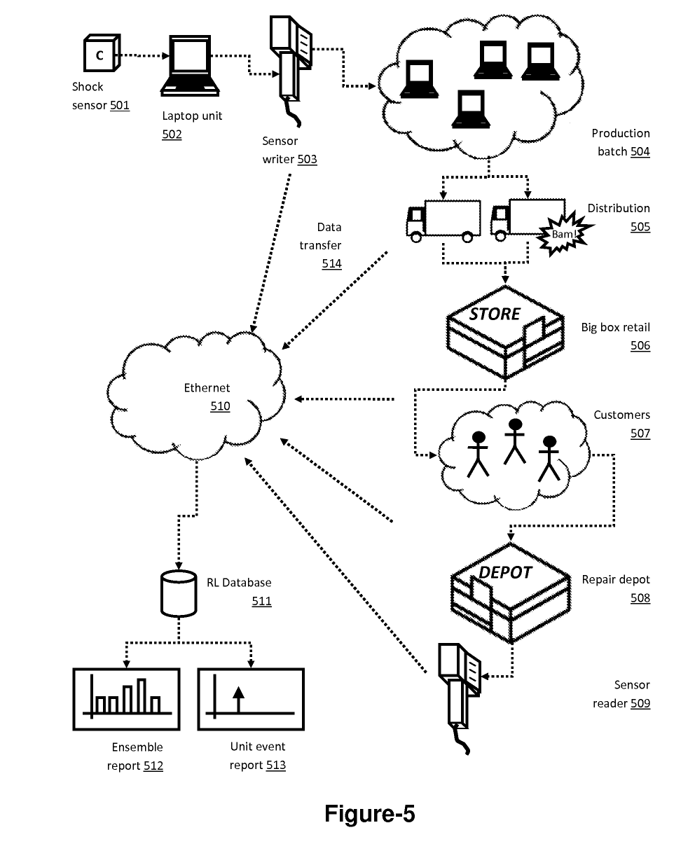

Upon receipt of the unit, end user assumes accountability for the unit(s). This is recorded as the transfer to the end user 209 and the timestamp on this event is dispatched to the analysis system 204. The data on the unit(s) transfer is recorded 210 and then integrated 213 into the database 215. Note that the process flow described here subsumes several entities within the end user 202 entity. For instance, for a consumer electronics manufacturer, the end-user includes the retailer as well as the consumer who purchases a specific unit from the retailer. This example is further discussed in FIG. 5. The critical point of note is that if multiple hand-offs take place within the end-user entity, data on each of the transfers is recorded, in step 210, integrated in step 213 and appended to the database in step 215; thus capturing the timeline of the accountability on the unit through its lifetime.

Despite the transfer of the unit from the manufacturer to the end-user, the manufacturer continues to guarantee the performance of the unit and its constituent parts. This guarantee is limited to ‘normal’ use, to within a manufacturer specified time window. If the unit should fail to perform, or if the end-user wishes to return the product for any reason acceptable to the manufacturer, the end-user initiates the return process 211. The request to return is transferred to the analysis system 204 and duly recorded, in step 212. The corresponding data are integrated, in step 213 and appended to the database, in step 215.

FIG. 3 is a continuation of the process flow shown in FIG. 2. The returned unit in step 211 is transferred to the service channel partner 203 (and 303) via a sub-process 214. The database updates from the analysis system 204 (and 304) via a sub-process 216.

Upon receipt of the returned unit the service channel partner 303 reads data from the returned unit via a sub-process 305. The read data captures the return receipt date as well as the data on the embedded sensor. This data contains the history of the use/abuse of the product from the time the unit left the production line till its return to the service channel partner, and is recorded to the analysis system via step 308 and integrated with the database, in step 311. Meanwhile the service channel partner 303 conducts diagnostics, in step 309 on the returned unit. The diagnostics data can include, for example, any complaints or requests from the end-user, the observed symptoms, the diagnosis of the underlying issue and the proposed resolution. These diagnostics data are transferred to the analysis system 304, recorded in step 310 and integrated into the database.

At this point, the analysis system conducts the audit in step 312 on the unit. Two types of reports are generated—the unit abuse profile 313, and the ensemble abuse profile 314. The unit abuse profile is a report on what transpired on the unit since the time it left the production line. The ensemble abuse profile 314 is a report on the production batch or on a particular class of units.

The key benefit of this invention is its ability to record data at every stage of the products' logistical process and make these available for statistical analysis to the analysis sub-system first described in FIG. 4. This enables hitherto insights into the logistical process. We illustrate this through the embodiments described below.

In one embodiment the present invention is used to estimate the risk of product failure due to exposure of the unit(s) to abuse. The system in the present invention captures the abuse data through the sensors distributed among the units. These data, with the respective timestamps, are then transferred to the analysis system where reliability analysis on the associated logistics process is performed. In one scenario, any abuse to the product units is captured on the sensors that are inside or co-located with the units. These sensors measure aberrations such as temperature extremes and shocks in the product environment. When every batch of failed units is received at the repair depot, any units that have registered abuse are separated from the rest, and analysis is conducted to understand if the events that transpired in their history had an impact on their lifetimes. The timestamp data are further needed in isolating where and when in the logistics process the abuse occurred.

In one embodiment, the time to failure for a product unit is modeled with the two parameter Weibull distribution. Let x be the time to failure. One suitable measure for the time to failure is the number of days between the manufacturing date and the date on which the customer reports product failure. The probability density function for the corresponding stochastic process is represented as below with β>0 as the shape parameter and τ>0 as the scale parameter

$$f ( x ) = \{ \begin{matrix}\frac{β}{τ} {( \frac{x}{τ} )}^{β - 1} exp - {( \frac{x}{τ} )}^{β} & x \geq 0 \\ 0 & x < 0.\end{matrix}$$

Given an observation dataset {b x₂, x₂,. . . ,xₙ} where xⱼ, is the time to failure for the j^{th} failed unit and n is the total number of elements, the underlying random process is assumed to have the above density function. With this assumption the maximum likelihood estimate β for the shape parameter is estimated by iteratively solving the following equation for β

$$\frac{{\sum }_{1}^{n} {x}_{i}^{β} ln {x}_{i}}{{\sum }_{1}^{n} {x}_{i}^{β}} - \frac{1}{β} = \frac{1}{n} {\sum }_{1}^{n} ln {x}_{i}$$

The maximum likelihood estimate I for the shape parameter is then estimated as

$$\hat{τ} = \frac{{\sum }_{1}^{n} {x}_{i}^{\hat{β}}}{n}$$

See A. C. Cohen, “Maximum likelihood estimation in the Weibull distribution based on complete and on censored samples”, Technometrics, Vol. 7 No. 4, 1965 for further details on parameter estimation for censored samples.

In one embodiment of the present invention, the parameter estimates generated as above model the probability density function for the time to failure for abused units. Thus the likelihood of product failure in D days or less is estimated as

$$Pr \{ x < D \} = {\int }_{0}^{D} \frac{\hat{β}}{\hat{τ}} {( \frac{x}{\hat{τ}} )}^{\hat{β} - 1} exp - {( \frac{x}{\hat{τ}} )}^{\hat{β}} d x .$$

The present invention thus helps the manufacturer understand the risk to their bottom line and to their warranty reserves if their products are subjected to specific conditions in transportation or in usage.

In another embodiment, the present invention is used to assess whether subjecting product units to specific conditions ultimately has an impact on their failure rates. This hypothesis directly comes from available sensor data which indicates whether a unit has been subject to abuse or to stress or to any other specific operating condition. So, when a new batch of failed units is received at the repair depot the units are split into two batches, the ‘null’ set comprising the units whose sensors did not record any abuse events, and the ‘test’ set comprising units whose sensors recorded the abuse phenomenon or the ‘event of interest’ under consideration. The business objective is an assessment whether the two batches are failing at the same rate. This task is framed as a statistical test whether the failure times for the ‘null’ set is less than the ‘test’ set. The method of analysis is described by A. S. Qureishi in The Discrimination Between Two Weibull Processes', in Technometrics, Vol. 6, no. 1, 1964. The implementation is described below.

In this scenario, let {x^{N}₁, x^{N}₂, . . . , x^{N}ₙ} represent the failure times for the units comprising the ‘null’ set, and let {x^{T}₁, x^{T}₂, . . . , x^{T}ₙ} represent the failure times for the units comprising the ‘test’ set as as associated with product units whose sensors attached thereto recorded the event of interest. Without loss of generality, for convenience the size of the respective samples is set as the same at n. Each data set is assumed as having been drawn from a Weibull random process. As explained earlier the shape and the scale parameters for the ‘null’ population can be estimated from observation data. These are represented as β^{N} and τ^{N} respectively for ‘null’ set; the shape and scale parameters for the ‘test’ population are similarly estimated as β^{T} and τ^{T}. The average failure times for the ‘null’ and the ‘test’ processes are computed as T^{N}=β^{N}Γ(1/τ^{N}+1) and T^{T}=β^{T}Γ(1/τ^{T}+1) respectively, where Γ(.) is the Gamma function. The estimates provide the claims manager guidance on the average failure times for the units that have been subjected to abuse; for comparison the average failure time for the normal or the ‘null’ population is also estimated. The difference in these estimates establishes if, and by how much the abuse affected the failure rates of the product units. The change in failure rates due to a breakdown in the logistics process has a direct impact on the company's profitability. The warranty reserve calculation below is adapted from Blischke and Murthy, “Product Reliability Handbook”, Dekker, 1996 and W. W. Menke, “Determination of warranty reserves”, Management Science, Vol. 15, No. 10, Jun. 1969.

In this embodiment we assume that a manufacturer's warranty coverage is the pro-rata type wherein the compensated amount is a fraction of the production cost, with the fraction based on the amount of time elapsed into the warranty period. If the production cost per unit is C₀, the warranty period is W, the average time to failure is T and the number of units under warranty is n, then the warranty reserve R to provide coverage for n units through the warranty period is

$$R = {\int }_{0}^{W} \frac{n}{T} ( {C}_{0} + \frac{R}{n} ) [ 1 - \frac{x}{W} ] ( 1 - {e}^{- \frac{x}{T}} ) d x$$

Note that the multiplier (C₀ +R/n)(1 −x/W) represents the pro-rated warranty cost for a unit under coverage. The above equation is solved for R to yield the following expression.

$$R = n ( {C}_{0} + \frac{R}{n} ) [ 1 - \frac{T}{W} ( 1 - {e}^{- W / T} ) ] .$$

Ergo, if the abuse affects the failure rates for product units, the impact to the warranty reserves can directly be impacted using the formula above. As above, if the ‘null’ process with no influence from abuse events has T^{N}=β^{N}Γ(1/β^{N}+1) as the average time to failure, and T^{T}=β^{T}Γ(1/β^{T}+1) is the average time to failure for the batch with exposure to the abuse phenomena, then the incremental cost to the manufacturer for handling the latter batch is reported as nC₀W[1/T^{N}(1 −exp(−W/T^{N}))−1/T^{T}(1 −exp(−W/T^{T}))].

The invention comprises a mechanism for collecting, aggregating and analyzing data from a distributed system. It is key that the data on the product universe are captured with timestamps for the recorded events. The goal of knowing not only ‘if’ but also the ‘when’ and the ‘what’ of all events in a product's lifetime is to improve reliability assessment under different real-world conditions. In another embodiment of the present invention, the reports from the analysis sub-system, with reference to FIG. 4, can establish if there is a causal relationship between abuse events and warranty claims as registered on the same timeline. For one application consider the scenario where a manufacturer ships consumer electronics products from Taiwan to Los Angeles. Occasionally the containers get dropped and the units register impact. This may be an unavoidable part of the shipping process but it is important for the claims manager to know if this has an effect on subsequent warranty claims. If a causal relationship does not exist there need be no incremental investment in packaging. Without the data and the insights the claims manager cannot make a fact based decision in his/her company's interest. The system and the process of the present invention provide the necessary insights. In yet another embodiment where low-priced consumer products will not practically have a sensor installed in each product unit it is more realistic to use sensors in the container within which the units are shipped. Information is only available at an aggregate batch level in this case.

For a business that ships several containers a day the invention captures the impacts were delivered to the product batch in a container on a given day. This information is transported to the repair depot wherein the serial numbers of the failed units are linked back to the batches that were impacted in transit. The statistical problem then reduces to assessing whether the impacts on an aggregate basis led to a spike in warranty claims several weeks/months later. The underlying statistical analysis to answer this problem is described below.

Let n₁ observations if {f₁,f₂, . . . , fₙ₁} represent the number of units received at a claims center over a period of n₁ consecutive weeks, and let there be a set of n₂ measurements {g₁, g₂, . . . , gₙ₁} representing the number of units that registered abuse events (recorded by the system over an overlapping period of n₂ consecutive weeks on the same timeline). FIG. 8 is an illustration of the abuse events data overlaid across the claims volume. A visual test is sufficient to frame a hypothesis if a bump in the number of abused units led to a spike in warranty claims (approximately) p weeks later. In the scenario below, the hypothesis is extended to cover the five week window represented as five points in the {p−1,p,p +1,p +2, p +3} moving window. Principal component analysis is used to validate (or disprove) this hypothesis.

To apply the analysis, the time series {g₁, g₂, . . . , gₙ₁} is checked to identify the months which saw the abuse events. These are identified as the k weeks represented as {t₁, t₂, ..., tₖ}. To test the hypothesis that the abuse led to a premature recall in p months the time series of claims volume {f₁, f₂, ..., fₙ₁} is transformed to a multidimensional array as below.

$$\begin{matrix}F = [ \begin{matrix}{f}_{- 1} \\ f \\ {f}_{+ 1} \\ {f}_{+ 2} \\ {f}_{+ 3} \\ {f}_{NULL}\end{matrix} ] \\ = [ \begin{matrix}{f}_{{t}_{1} + p - 1} & … & {f}_{{t}_{k} + p - 1} \\ {f}_{{t}_{1} + p} & … & {f}_{{t}_{k} + p} \\ {f}_{{t}_{1} + p + 1} & … & {f}_{{t}_{k} + p + 1} \\ {f}_{{t}_{1} + p + 2} & … & {f}_{{t}_{k} + p + 2} \\ {f}_{{t}_{1} + {p}_{+ 3}} & … & {f}_{{t}_{1} + p + 3} \\ {\sum }_{m = - 10}^{10} {f}_{{t}_{1} + p + m} - {\sum }_{m = - 1}^{3} {f}_{{t}_{1} + p + m} & … & {\sum }_{m = - 10}^{10} {f}_{{t}_{k} + p + m} - {\sum }_{m = - 1}^{3} {f}_{{t}_{k} + p + m}\end{matrix} ]\end{matrix}$$

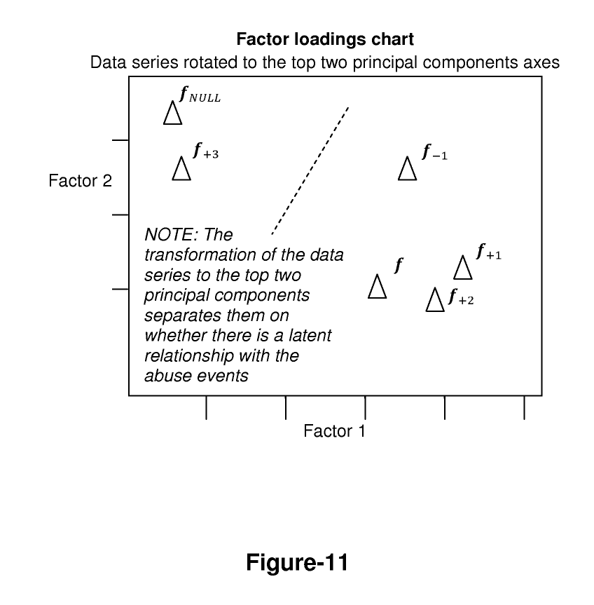

Each row in the array comprises k data elements with fₜₖ₊ₚ representing the number of warranty claims received in week tₖ +p. The last row in the array represented as f_{NULL} comprises the number of claims received in a fixed 21 point window less the claims volume for the five point moving window {p−1,p,p +1,p +2, p +3} under the test hypothesis. Note that the 21 points of the reference or the ‘Null’ window is for the purpose of illustration. The actual implementation of the ‘Null’ and the ‘test’ windows can be is adapted based on the hypotheses the analyst wants to test. Principal component analysis is applied to reduce the dimensionality of the data and to understand the underlying relationship structure. If product abuse does indeed lead to a claims spike about p weeks after the event, the transformation of the data to the principal component dimensions reveals the latent separation among the claims data series. See FIG. 11 for an illustration of the analysis output. To get to FIG. 11, the data series in F were rotated to the principal components corresponding to the top two eigenvalues. The resulting factor loadings may be seen as in FIG. 11. In this example, we note that the f₋₁, f, f₊₁, f₊₂ are separate and distinct from the data for f_{NULL}, f₊₃ . In other words we conclude an abuse events led to a spike in claims p−1, p, p +1 weeks from the week of the event (corresponding to f₋₁, f, f₊1, f₊₂). According to one aspect of the present invention, this implementation is adapted from the statistical analysis described by Gousheva, M. N., Georgieva, K. Y. , Kirov, B., and Atanasov, D, “On the relation between solar activity and seismicity”, RAST 2003: Proceedings of the International Conference on Recent Advances in Space Technologies, held Nov. 20-22, 2003, in Istanbul, Turkey.

In yet another embodiment of the invention to understand the causal relationship between abuse and claims, the method of autoregressive analysis is used by the analysis sub-system 406 with reference to FIG. 4. In this embodiment the time series of the number of claims {f₁, f₂, ..., fₙ₁}is modeled as an auto-regressive process with a₁, . . ., a_{q} as the q model parameters and ε_{1, K} as the white noise component.

$${f}_{k} = {\sum }_{j = 1}^{q} {a}_{j} {f}_{k - j} + {ɛ}_{1 , k}$$

The same time series may also be jointly modeled with the time series of the abuse events {g₁, g₂, . . . , gₙ₂}. The representation of the process, with q₁+q₂ model parameters b₁, . . . ,b_{q1}, c₁, . . . , c_{q2} and the white noise component E_{2,k} is

$${f}_{k} = {\sum }_{j = 1}^{{q}_{1}} {b}_{j} {f}_{k - j} + {\sum }_{i = 1}^{{q}_{2}} {c}_{i} {g}_{k - i} + {ɛ}_{2 , k}$$

The variances of the white noise components in the respective processes are var(ε_{1,k})=σ²₁, var(ε_{2,k})=σ²₂.

The value of σ²₁ measures the accuracy of the autoregressive prediction of fₖ based on its previous values, whereas the value of σ²₂ measures the accuracy of predicting the present value of fₖ based on the previous values of both fₖ and gₖ. If σ²₂ is significantly less than σ²₁ then gₖ is said to exert a causal influence on fₖ. The details on the method for estimating the white noise variances can be obtained in C. W. Granger's “Investigating causal relations by econometric models and cross-spectral methods”, Econometrica, Vol 37, and in N. Wiener's “The theory of prediction” in Chapter 8 of Modern Mathematics for Engineers, McGraw-Hill.

Further embodiments of the invention are described below using scenarios adapted from real-world situations. In one embodiment of the present invention, by way of example in FIG. 5, a laptop manufacturer installs a shock abuse sensor 501 in every laptop 502 during the assembly. The sensor tag is initialized and encoded with the serial number of the laptop using a writer device 503. These data are then transferred, in step 514, to a centralized repository, the RL (for Reverse Logistics) database 511. The production batch of laptops 504 is shipped via the manufacturer's distribution network 505. Some of the shipment is damaged in transit with a pallet being dropped or a collision to a delivery truck. This damage does not necessarily get registered by the shipper and the laptops are delivered to a retailer 506 for sale to consumers 507. The sales and warranty information on the laptops is recorded in the centralized database 511. Over time some of the laptops sold by the retailer show defects that cannot be fixed through call-in technical support. If the elapsed time is within the manufacturer's warranty period, the defective laptops are dispatched to a repair depot 508 under contract with the manufacturer. Upon receipt at the depot 508 the laptops are scanned, in step 509, and any shock events that have been recorded since the sensors' initialization at the manufacturer's assembly are transferred, via step 514, to the RL database 511. An ensemble level report 512 at the production batch level is generated for all laptops received thus far at the depot. The invention helps the manufacturer deduce that the spike in warranty claims is due to an impact in transit, and also estimate the expected failure rate for other laptops that were part of the impacted shipment (useful for gathering inventory of replacement parts).

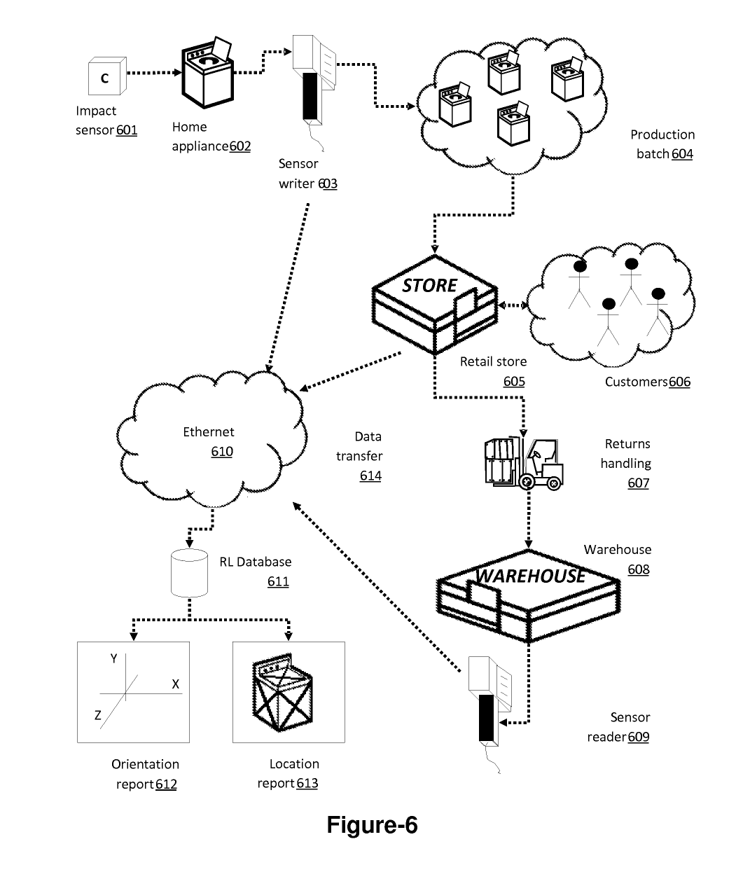

In another embodiment of the present invention, by way of example in FIG. 6, a home appliance manufacturer installs impact sensors 601 in every appliance (such as a washer) 602 during the assembly. The sensors contain an accelerometer that records G-force impact in three dimensions. The sensor tags are initialized and encoded with the serial numbers of the respective appliances using a writer device 603. These data are transferred to a centralized repository, the RL (for Reverse Logistics) database 611. These appliances, the production batch 604, are distributed via big box retail stores 605. In North America, with support from the manufacturer, many large retail stores offer customers the opportunity to return purchased items at little or no penalty. The industry expression for such a practice is ‘goodwill return’. The items received as goodwill returns are restocked, in step 607, and often transferred back to the manufacturer's warehouse 608. Through this transfer process, many manufacturers observe ‘shrinkage’ to the returned inventory. Shrinkage is the phenomenon where the received items are damaged in transit or in the process of returns handling. This is a severe problem for manufacturers. Manufacturers measure the overall shrinkage but do not have the capability to isolate the preventable shrinkage and consequently take action to reduce their losses. This invention is presented as a potential solution. When the returned appliances are received at the warehouse, they are scanned using sensor readers 609 and any impact events stored on the affixed sensors 601 are transferred to the RL database 611 for analysis. These data are next analyzed and two types of ensemble reports are produced to identify what impacts leads to shrinkage and what is the associated risk.

Orientation reports 612 identify the direction of the impact in respect to the three axes based on the direction of the acceleration recorded by the sensor. The direction is dependent on the direction and the angle of the impact. The Location reports 613 pinpoint the geophysical location where the impacts are observed based on the time the impacts were recorded by the sensor, and corresponding data on the dates of manufacture, ship, purchase, or repair. The analysis potentially reveals problems in the reverse logistics process where the packaging or the transfer pallets are inadequate to the appliances being handled or insufficient padding being applied to soften the impacts and vibrations.

For example, as LCD panels are getting bigger and thinner, they may not possess the same resilience a smaller and more bulky LCD panel from 5 years ago possessed. If same padding is used, and the sensor shows most damage happening in the warehouse during the loading/unloading stage, it could point to inefficient padding or too rough handling techniques being used. Furthermore, the orientation report 612, together with location report 613 can be used to identify the damage prone spots on the unit and the origin of the damaging impact; therefore to pinpoint exactly where in the packaging more padding is needed. In another embodiment of the present invention, one of the orientation report and location report alone may be sufficient to determine the weak spot of the packaging. An ensemble report is used to estimate the probability of failure under different scenarios for the logistics process. The manufacturer then weighs the cost of implementing the countermeasure against the continued risk of loss before deciding the appropriate course of action.

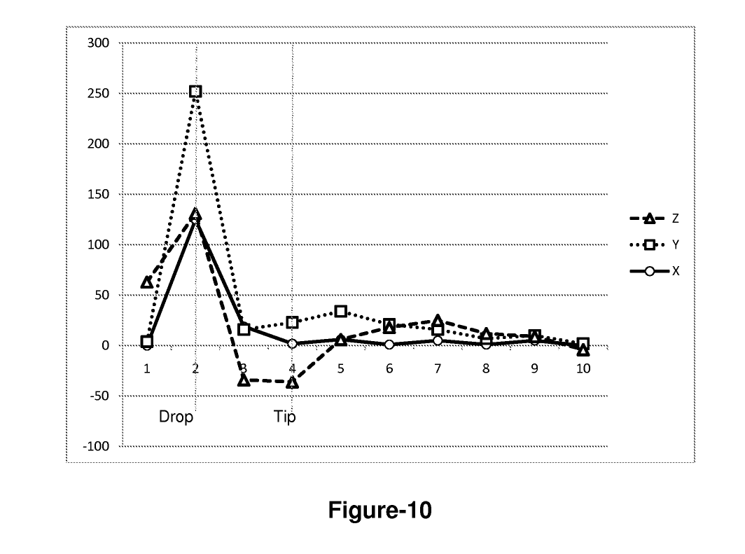

In reference to FIG. 10, an illustrative unit report on the G-sensor readings in three dimensions that can be used to understand the nature of the impact, is shown. In this example a G-sensor with readings in 3 dimensions was located on a product unit. The unit was being transported in a larger container, when it got dislodged from its mooring upon impact. The moment of impact and the subsequent tip-over is observed in FIG. 10. The initial impact registered the most on the Y-axis as observed in FIG. 10. The tip-over is demonstrated by the change in the acceleration direction on the Z-axis.

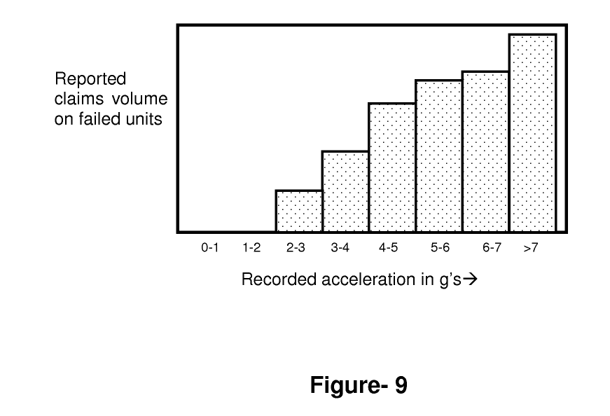

The present invention is useful in estimating the tolerance limit of product units to various abuse in their handling and usage by the consumer. For example, after receiving and processing claims data on failed units, an ensemble report such as FIG. 9 is generated. FIG. 9 shows the distribution of the claims ordered on the g-force acceleration to which the failed units have been exposed by the end user. By observing the claim volume, the manufacturer understands the typical use to which its products are subjected in the field. This helps in redesigning product casing or the components to have a higher tolerance.

The description of the invention is merely exemplary in nature and, thus, variations of the above disclosed embodiments can also be made to accomplish the same functions. For example, the analysis system can be a computer with Internet portal capability for receiving and sending data. The analysis system can also be a stand-alone computing device with reading/displaying capability or with communication interface for receiving and sending data wired or wirelessly. Further, all the functions of analysis system can be implemented fully inside the analysis system. Alternatively, some functions are implemented inside analysis system whereas the rest are implemented at a different site such as manufacturer's or service channel partner's, who is responsible for generating the reports or utilizing the reports to make claim acceptance/rejection recommendations.

Yet further, in reference to FIG. 2, a single functional module or device or step, in lieu of three separate modules: reader, transporter and loader, may act as receiving data from the sensor and transmitting to the central RL database. An exemplary implementation could be that each unit has an on-board computer and direct network link to the central RL database. Therefore, direct communication and data transfer can be realized between a unit and central RL database using standard networking protocol such as ftp/http.

Yet further, the central RL database may not be a single database. It could also be located in several locations, each responsible for different category of information or logistics. For example, all product warranty information is stored in one RL database, whereas all abuse event information is stored in another database at the same or different location.

Still further variations, including combinations and/or alternative implementations, of the embodiments described herein can be readily obtained by one skilled in the art without burdensome and/or undue experimentation. Such variations are not to be regarded as a departure from the spirit and scope of the invention.

What is claimed is:

1. A method of assessing product reliability associated with an event of interest on a given class of product, said method comprising the steps of:
retrieving warranty claim information and event data for said given class of product, whereby said event data are recorded by one or more sensors attached to said given class of product unit and said event data contain at least a timestamp associated with each recorded event;
assessing product reliability using a computer, based on warranty claim information, said recorded event data, and timestamp associated with each recorded event.

2. The method of claim 1, wherein said assessing step further comprises the steps of:
forming an analysis dataset from said warranty claim information and said event data for said given class of product, whereby the elements in said analysis dataset are associated with product units whose one or more sensors attached thereto recorded the event of interest; and
estimating product reliability based on said formed analysis dataset.

3. The method of claim 2, wherein said estimating step further comprises the steps of:
forming an observation {x₁, x₂, ..., xₙ}, where each xⱼ, is the time to failure for the j^{th} element in said formed analysis dataset and n is the total number of elements in the formed analysis dataset;
estimating Weibull distribution shape parameter β and scale parameter τ from said observation {x₁, x₂, ..., xₙ}; and
estimating the probability of product failure on or before a time D as Pr{x <D };
wherein β is obtained based on the solution of the following
$$\frac{{\sum }_{1}^{n} {x}_{i}^{β} ln {x}_{i}}{{\sum }_{1}^{n} {x}_{i}^{β}} - \frac{1}{β} = \frac{1}{n} {\sum }_{1}^{n} ln {x}_{i} ;$$
equation for β,
$$\hat{τ} = {\sum }_{1}^{n} {x}_{i}^{\hat{β}} ; and$$
$$Pr \{ x < D \} = {\int }_{0}^{D} \frac{\hat{β}}{\hat{τ}} {( \frac{x}{\hat{τ}} )}^{\hat{β} - 1} exp - {( \frac{x}{\hat{τ}} )}^{\hat{β}} d x .$$
τis obtained based on

4. The method of claim 1, wherein the assessing step includes estimating incremental cost associated with said event of interest.

5. The method of claim 4, wherein the estimating of incremental cost further comprises the steps of:
forming a first analysis dataset from said warranty claim information and said event data for said given class of product, whereby the elements in said first dataset are associated with product units whose one or more sensors attached thereto did not record the event of interest;
forming a second analysis dataset from said warranty claim information and said event data for said given class of product, whereby the elements in said second dataset are associated with product units whose one or more sensors attached thereto recorded the event of interest;
calculating an average time to failure of said first analysis dataset;
calculating an average time to failure of said second analysis dataset;
calculating an incremental cost based on the difference of the average time to failure of said first analysis dataset and the average time to failure of said second analysis dataset, a per unit production cost, a warranty period set by manufacturer, and the number of units under warranty.

6. The method of claim 5, wherein said calculating incremental warranty cost is based on nC₀W[1/T^{N}(1−exp(−W/T^{N}))−1/T^{T}(1−exp(−W/T^{T}))],
where C₀ is the per unit production cost, W is the warranty period is, n is the number of units under warranty, T^{N} is the average time to failure of said first analysis dataset and T^{T} is the average time to failure of said second analysis dataset.

7. The method of claim 5, wherein said step of calculating average time to failure of said first analysis dataset further comprises the steps of:
estimating Weibull distribution shape parameter β^{N} and Γ^{N} from an observation {x₁, x₂, . . . , xₙ}, where each xⱼ, is the time to failure for the j^{th} event in said first analysis dataset and n is the total number of elements in said first analysis dataset; and
estimating an average failure time as T^{N}=β^{N}σ(1/Γ^{N} +1) , where σ(.) is a Gamma function.

8. The method of claim 5, wherein said step of calculating average time to failure of said second analysis dataset further comprises the steps of:
estimating Weibull distribution shape parameter β^{T} and scale parameter τ^{T} from an observation {y₁, y₂, yₙ}, where each yⱼ is the time to failure for the j^{th}” event in said second analysis dataset and n is the total number of elements in said second analysis dataset; and
estimating an average failure time as T^{T}=β^{T}Γ(1/τ^{T}+1) , where Γ(.) is a Gamma function.

9. The method of claim 1, wherein the assessing step further comprises:
forming an event time series from said event data containing said event of interest;
forming a warranty claim volume time series from said warranty claim information;
determining, using a statistical test, if the event of interest had an impact on product warranty claims;
whereby the statistical test detects a causal relationship between the event time series and the warranty claim volume time series.

10. The method of claim 10, wherein said causality test is based on the method of autoregressive time series analysis.

11. The method of claims 10 wherein said statistical test is based on principal component analysis.

12. The method of claim 1, wherein said event of interest is one of impact, drop, tip-over, extreme temperature or moisture seepage.

13. The method of claim 1, wherein at least one of said one or more sensors is a sensor selected from a group comprising accelerometer sensor, tilt sensor, temperature sensor, G-force sensor, shock sensor and GPS sensor.

14. A product reliability assessment system for use in estimating product reliability associated with an event of interest on a given class of product comprising:
a retrieving module for retrieving warranty claim information and event data for said given class of product unit, whereby said event data are recorded by one or more sensors attached to said given class of product unit and said event data contain at least a timestamp associated with each recorded event;
a forming module for forming an analysis dataset from said warranty claim information and said recorded event data, whereby the elements in said analysis dataset are associated with product units whose one or more sensors attached thereto recorded the event of interest; and
an analytical subsystem for estimating the product reliability based on said analysis dataset using at least the timestamp associated with each recorded event.

15. The system of claim 14, wherein said analytical subsystem further comprises:
a Weibull module for estimating Weibull distribution shape parameter β and scale parameter τ from an observation {x₁, x₂, . . . , xₙ}, whereby each xⱼ, is the time to failure for the j^{th} element in the formed analysis dataset and n is the total number of elements in said formed analysis dataset; and
a probability module for estimating the probability of product failure on or before a time D as Pr{x<D };
where β is obtained based on the solution of the following
$$\frac{{\sum }_{1}^{n} {x}_{i}^{β} ln {x}_{i}}{{\sum }_{1}^{n} {x}_{i}^{β}} - \frac{1}{β} = \frac{1}{n} {\sum }_{1}^{n} ln {x}_{i} ;$$
equation for β,
$$\hat{τ} = {\sum }_{1}^{n} {x}_{i}^{\hat{β}} ; and$$
$$Pr \{ x < D \} = {\int }_{0}^{D} \frac{\hat{β}}{\hat{τ}} {( \frac{x}{\hat{τ}} )}^{\hat{β} - 1} exp - {( \frac{x}{\hat{τ}} )}^{\hat{β}} d x .$$
τ is obtained based or

16. A product reliability assessment system for use in estimating product reliability associated with a product abuse event on a given class of product comprising:
a retrieving module for retrieving warranty claim information and event data for said given class of product, whereby said event data are recorded by one or more sensors attached to said given class of product and said event data contain at least a timestamp associated with each recorded event; and
an assessor for assessing impact of product abuse on subsequent warranty claims using said warranty claim information, said event data and timestamp associated with each event.

17. The system of claim 16, wherein said assessor further comprising.
a forming module for forming a first analysis dataset from said warranty claim information and said event data, whereby the elements in said first analysis dataset are associated with product units whose one or more sensors attached thereto did not record the product abuse event;
a forming module for forming a second analysis dataset from said warranty claim information and said event data, whereby the elements in said second analysis dataset are associated with product units whose one or more sensors attached thereto recorded the product abuse event; and
a first calculating module for calculating average time to failure of said first analysis dataset;
a second calculating module for calculating average time to failure of said second analysis dataset; and
an analysis sub-system for calculating an incremental cost based on the difference of the average time to failure of said first analysis dataset and the average time to failure of said second analysis dataset, a per unit production cost, a warranty period set by manufacturer, and the number of units under warranty.

18. The system of claim 16, wherein said product abuse event corresponds to the triggered measurement on one or more of accelerometer sensor, tilt sensor, temperature sensor, G-force sensor, shock sensor or GPS sensor.

19. The system of claim 17, wherein said first calculating module further comprises:
a first estimator for estimating Weibull distribution shape parameter a and scale parameter I from an observation {x₁, x₂, . . . , xₙ}, where each xⱼ, is the time to failure for the j^{th} element in said first analysis dataset and n is the total number of elements in said first analysis dataset; and
a second estimator for estimating average time to failure T for said first analysis dataset;
whereby β is based on
$$\frac{{\sum }_{1}^{n} {x}_{i}^{β} ln {x}_{i}}{{\sum }_{1}^{n} {x}_{i}^{β}} - \frac{1}{β} = \frac{1}{n} {\sum }_{1}^{n} ln {x}_{i} ;$$
τ is based on
$$\hat{τ} = \frac{{\sum }_{1}^{n} {x}_{i}^{\hat{β}}}{n} ;$$
and T=βΓ(1/τ+1), where n is the total number of elements in said first analysis dataset, Γ(.) is a Gamma function.

20. The system of claim 17, wherein said second calculating module further comprises:
a first estimator for estimating Weibull distribution shape parameter Γ and scale parameter τ from an observation {y₁, y₂, ..., yₙ}, where each yᵢ is the time to failure for the j^{th} element in said second analysis dataset and n is the total number of elements in said second analysis dataset; and
a second estimator for estimating average time to failure T for said second analysis dataset;
whereby β is based on
$$\frac{{\sum }_{1}^{n} {y}_{i}^{β} ln {y}_{i}}{{\sum }_{1}^{n} {y}_{i}^{β}} - \frac{1}{β} = \frac{1}{n} {\sum }_{1}^{n} ln {y}_{i} ;$$
τ is based on
$$\hat{τ} = \frac{{\sum }_{1}^{n} {y}_{i}^{\hat{β}}}{n} ;$$
and
T=βΓ(1/Γ+1), where n is the total number of elements in said second analysis dataset, Γ(.) is a Gamma function.
